(19) United States
(12) Patent Application Publication
(10) Pub. No.: US 2009/0188233 A1
(43) Pub. Date: Jul. 30, 2009

(54) THRUST REVERSER FORMING AN ADAPTIVE NOZZLE

(75) Inventors: Guy Bernard Vauchel, Le Havre (FR); Pierre Andre Marcel Baudu, Criquetot l'Esneval (FR)

Correspondence Address: CANTOR COLBURN, LLP, 20 Church Street, 22nd Floor, Hartford, CT, 06103, US

(73) Assignee: AIRCELLE, Gonfreville l'Orcher (FR)

(21) Appl. No.: 12/302,892

(22) PCT Filed: May 2, 2007
(86) PCT No.: PCT/FR2007/000746

§ 371 Date: Nov. 30, 2008

(30) Foreign Application Priority Data
Jun. 21, 2006 (FR) 0605512

(51) Int. Cl. F02K 3/02

(52) U.S. Cl. 60/226.2

(57) ABSTRACT

The present invention relates to a thrust reverser for the nacelle of a turbojet engine comprising, on the one hand, means (11) for deflecting at least some of an air flow of the turbojet engine and, on the other hand, at least one hood (10) able to move translationally in a direction substantially parallel to a longitudinal axis of the nacelle and able to switch alternately from a closed position in which it ensures the aerodynamic continuity of the nacelle and covers the deflection means, and an open position in which it opens a passage in the nacelle and uncovers the deflection means, characterized in that the moving hood comprises at least one outer part (10a) having a downstream extension forming a nozzle and at least one internal part (10b) each of which parts is mounted such that it is translationally mobile and is connected to at least one actuating means able to allow it to be moved, each independently of the other, or together, in a substantially longitudinal direction of the nacelle. The present invention also relates to a turbojet engine nacelle comprising such a thrust reverser.

### TECHNICAL FIELD OF THE INVENTION

The present invention relates to a thrust reverser for a turbine engine nacelle comprising, on the one hand, means for deflecting at least a fraction of an air stream of the turbine engine and, on the other hand, at least one cowl which can move translationally in a substantially longitudinal direction of the nacelle and which is able to switch alternately from a closed position in which it provides aerodynamic continuity of the nacelle and covers the deflection means, to an open position in which it opens a passage in the nacelle and uncovers the deflection means. The present invention also relates to a turbine engine nacelle comprising such a thrust reverser.

### BRIEF DESCRIPTION OF RELATED ART

An aircraft is propelled by a number of turbine engines each housed in a nacelle which also accommodates a collection of auxiliary actuating devices associated with the operation thereof and performing various functions when the turbine engine is operating or not running. These auxiliary actuating devices comprise in particular a mechanical system for actuating thrust reversers.

A nacelle generally has a tubular structure comprising an air intake upstream of the turbine engine, a central section intended to surround a fan of the turbine engine, a downstream section accommodating thrust reverser means and intended to surround the combustion chamber of the turbine engine, this section generally ending in an exhaust nozzle whose outlet is situated downstream of the turbine engine.

Modern nacelles are intended to accommodate a bypass turbine engine which is able, by means of the blades of the rotating fan, to generate a hot air stream (also known as the primary stream) coming from the combustion chamber of the turbine engine, and a cold air stream (secondary stream) which flows around the outside of the turbine engine through an annular passage, also known as a duct, formed between a shroud of the turbine engine and an internal wall of the nacelle. The two air streams are ejected from the turbine engine through the rear end of the nacelle.

The purpose of a thrust reverser is, when an aircraft is landing, to improve the ability of said aircraft to brake by redirecting forward at least some of the thrust generated by the turbine engine. During this phase, the reverser closes off the cold stream duct and directs this cold stream toward the front of the nacelle, thereby generating a reverse thrust which combines with the braking of the aircraft wheels.

The means employed to achieve this reorientation of the cold stream vary according to the type of reverser. However, in all cases, the structure of a reverser comprises movable cowls which can move between, on the one hand, a deployed position in which they open, within the nacelle, a passage intended for the deflected stream and, on the other hand, a retracted position in which they close this passage. These cowls may perform a deflecting function or may simply activate other deflecting means.

In the case of a cascade-type reverser, the air stream is reoriented by cascades of deflection vanes, the cowl merely having a simple sliding function with the aim of uncovering or re-covering these cascades, the translational movement of the movable cowl taking place along a longitudinal axis substantially parallel to the axis of the nacelle. Additional blocking doors, activated by the sliding movement of the cowling, are generally able to close off the duct downstream of the cascades so as to optimize the reorientation of the cold stream.

It is possible to avoid having to fit blocking doors by adapting the shape of the duct such that it has an S shape, that is to say that the engine shroud has a bulge which matches the inner wall of the nacelle formed by the cowling at this point. The height of the bulge is calculated so that the reverser cowling by itself closes off the duct as it slides into the reverser open position. In this case, the cascade-type reverser is known as a natural blockage cascade reverser, the sliding cowling naturally blocking off the cold stream duct by virtue of its shape and the shape of said duct.

A reverser of such type is described in documents FR 2 132 380 and U.S. Pat. No. 4,232,516, for example.

Apart from its thrust reversal function, the sliding cowl belongs to the rear section and has a downstream side forming an exhaust nozzle designed to channel the exhaust of the air streams. This nozzle may complement a primary nozzle which channels the hot stream and is then known as a secondary nozzle.

The thrust reverser performance is obtained in a satisfactory manner with the known devices. However, there remains a problem of adapting the powerplant to the various flight phases which it encounters, in particular the aircraft takeoff and landing phases for which the optimum cross sections of the secondary exhaust nozzle that have been defined for cruise flight conditions are no longer suited.

This problem has been solved for a cascade-type reverser in document FR 2 622 929, but it still remains for a natural blockage cascade reverser having an S-shaped secondary duct.

Document FR 2 622 929 solves this problem by proposing a cascade-type thrust reverser having a variable exhaust cross section and to this end provides a movable cowl comprising two portions which are able to be interconnected by locking means. More precisely, a movable reverser cowl according to FR 2 622 929 comprises a downstream portion which is able to be moved alone or with an upstream portion to which it can be optionally locked so as to allow, in a first instance, a movement of the entire movable cowl during a deployment of the reverser and, in a second instance, a movement of the downstream portion alone, thus modifying the nozzle outlet cross section.

### BRIEF SUMMARY OF THE INVENTION

The invention proposes a configuration adapted for a nacelle comprising a natural blockage cascade reverser installed more particularly, but without limiting it thereto, around a turbofan engine having a high bypass ratio.

The invention further proposes an alternative to the solution implemented in document FR 2 622 929.

The invention comprises a thrust reverser for a turbine engine nacelle comprising, on the one hand, means for deflecting at least a fraction of an air stream of the turbine engine and, on the other hand, at least one cowl which can move translationally in a direction substantially parallel to a longitudinal axis of the nacelle and which is able to switch alternately from a closed position in which it provides aerodynamic continuity of the nacelle and covers the deflection means, to an open position in which it opens a passage in the nacelle and uncovers the deflection means, characterized in that the movable cowl comprises at least one external portion having a nozzle-forming downstream extension and at least one internal portion, each of these portions being mounted such that they can move translationally and being connected to at least one actuating means enabling them to move, independently of one another or together, in a substantially longitudinal direction of the nacelle.

Thus, by dividing the movable cowl into an internal portion and an external portion which can move independently of one another at least in part, it is possible to adapt the relative positions of the external portion and the internal portion so as to vary the cross section of the nozzle formed by the movable cowl by varying the length of the internal aerodynamic line of said movable cowl, both when the movable cowl is in a closed position and covers the deflection means and when the movable cowl is in an open position. In this way, it is easy to adapt the cross section of the exhaust nozzle formed by the movable cowl to the flight conditions so as to maintain an optimum configuration.

Preferably, the external portion can be equally caused to make an advancing movement in the upstream direction of the nacelle or a retreating movement in the downstream direction of the nacelle with respect to the internal portion.

Advantageously, the external portion and the internal portion are separated at the location of a recess of an internal aerodynamic line of the movable cowl. This makes it possible to minimize the impact of the aerodynamic discontinuity that is represented by the interruption between the external portion and the internal portion.

Advantageously still, the internal aerodynamic line recess is intended, when the movable cowl is in the closed position, to be situated facing a bulge of a casing of the turbine engine that, together with the internal aerodynamic line of the movable cowl, defines an inner duct.

According to a first embodiment, the movable cowl is equipped, on the one hand, with a means for actuating one of the external or internal portions and, on the other hand, with locking means which are able to switch alternately from a locking position in which the external portion is connected to the internal portion, to an unlocking position in which the external portion or the internal portion connected to the actuating means is able to move independently of the other portion.

Advantageously, the actuating means is connected to the external portion.

According to a second embodiment, the movable cowl is equipped with an actuating means for the external portion and with an actuating means specific to the internal portion which are able to be activated independently of one another so as to allow, on the one hand, a simultaneous movement of the external portion and the internal portion and, on the other hand, a relative movement between the external portion and the internal portion.

Preferably, the actuating means comprise rams of the pneumatic, electric and/or hydraulic ram type.

Preferably, the actuating means comprise a telescopic ram having a first rod which is able to allow the movement of the internal portion and a second rod which is able to allow the movement of the external portion, the two rods being able to be controlled synchronously or independently of one another.

Alternatively or additionally, the actuating means comprise a screw/nut actuating system which can be actuated pneumatically, electrically and/or hydraulically.

Advantageously, the external and internal portions are equipped with guide means which are able to cooperate with complementary guide means connected to a fixed portion of the nacelle.

Preferably, the guide means are rails which are able to cooperate with corresponding grooves.

According to a first variant embodiment, the rails of the external portion and of the internal portion are separate.

According to a second variant embodiment, the rail of the external portion is integrated into the rail of the internal portion.

The present invention also relates to a turbine engine nacelle, characterized in that it comprises at least one thrust reverser according to the invention.

Advantageously, it is a nacelle for a bypass turbine engine, preferably with a high bypass ratio.

Preferably, the thrust reverser is a natural blockage thrust reverser.

### BRIEF DESCRIPTION OF THE DRAWINGS

The implementation of the invention will be better understood from the detailed description which is explained below with reference to the appended drawing, in which:

FIG. 1 is a schematic representation in longitudinal section of a nacelle of a bypass turbine engine with a high bypass ratio according to the prior art, equipped with a natural blockage cascade-type thrust reverser.

FIG. 2 is a detailed representation of a thrust reverser according to the invention.

FIG. 3 is a representation of a first variant arrangement of the actuating means shown in FIG. 2.

FIG. 4 is a representation of a second variant arrangement of the actuating means shown in FIG. 2.

FIG. 5 is a representation of a third variant arrangement of the actuating means shown in FIG. 2.

FIG. 6 is a representation of a fourth variant arrangement of the actuating means shown in FIG. 2.

FIG. 7 is a schematic representation of a first embodiment of the actuating means for the movable cowl of the reverser shown in FIG. 2.

FIG. 8 is a schematic representation of the reverser shown in FIG. 3 in a closed position forming an exhaust nozzle of minimum cross section.

FIG. 9 is a schematic representation of the reverser shown in FIG. 3 in a closed position forming an exhaust nozzle of maximum cross section.

FIG. 10 is a schematic representation of the reverser shown in FIG. 3 in an open position forming an exhaust nozzle of maximum cross section.

FIG. 11 is a schematic representation of the reverser shown in FIG. 3 in an open position forming an exhaust nozzle of minimum cross section.

FIG. 12 is a representation of a second embodiment of the actuating means for the reverser shown in FIG. 2.

FIG. 13 is a representation of a third embodiment of the actuating means for the reverser shown in FIG. 2.

FIG. 14 is a schematic representation of the embodiment shown in FIG. 13 in a closed position and forming an exhaust nozzle having a minimum cross section.

FIG. 15 is a schematic representation of the embodiment shown in FIG. 13 in an open position and forming an exhaust nozzle having a maximum cross section.

FIG. 1 represents a nacelle 1 for a bypass turbine engine with a high bypass ratio according to the prior art.

### DETAILED DESCRIPTION OF THE INVENTION

The nacelle 1 is intended to form a tubular housing for a bypass turbine engine (not shown) with a high bypass ratio and serves to channel the air streams that it generates via the blades of a fan (not shown), namely a hot air stream passing through a combustion chamber (not shown) of the turbine engine, and a cold air stream flowing around the outside of the turbine engine.

The nacelle 1 has a structure comprising a forward section which forms an air intake 4, a central section 5 surrounding the fan of the turbine engine, and a rear section surrounding the turbine engine and comprising a thrust reversal system.

The air intake 4 has an internal surface 4a intended to channel the incoming air and an external shroud surface 4b.

The central section 5 comprises, on the one hand, an internal casing 5a surrounding the fan of the turbine engine and, on the other hand, an external structure 5b shrouding the casing and extending the external surface 4b of the air intake section 5. The casing 5a is attached to the air intake section 4 that it supports and extends the internal surface 4a thereof.

The rear section comprises an external structure comprising a thrust reversal system and an internal engine-shrouding structure 8 which defines, together with the external surface, a duct 9 through which a cold stream is intended to flow in the case of a nacelle 1 for a bypass turbine engine like the one represented here.

Each thrust reversal system comprises a cowl 10 which can move translationally along a substantially longitudinal axis of the nacelle and which is able to switch alternately from a closed position in which it shields deflection cascades 11 and provides structural continuity of the central section 5, thus allowing the cold stream to be discharged through the duct 9 as a direct jet 3a, to an open position in which it uncovers the deflection cascades 11, thus opening a passage in the nacelle 1, and blocks off the duct 9 downstream of the deflection cascades 11, thus allowing the cold stream to be reoriented into a reverse jet 3b.

More specifically, the cascade-type reversal system depicted here is a natural blockage cascade reversal system. This means that the movable cowl 10 naturally blocks off the duct 9 in the open position without requiring the presence of any additional blocking doors.

To this end, the internal structure 8 of the rear section has, downstream of the deflection cascades 11, a bulge 12 which is large enough that it substantially reaches the level of the casing 5a of the nacelle 1. Thus, the inside diameter of the nacelle 1 at the outlet of the casing 5a of the central section 5 is substantially equal to the diameter of the internal structure 8 in the region of the bulge 12.

The movable cowl 10 has, on the one hand, an external surface 13 which is able to provide the external structural continuity of the nacelle 1 with the external structure 5b of the shroud of the casing 5a and, on the other hand, an internal surface 14 which is able to provide the internal structural continuity of the nacelle 1 with the casing 5a, the internal surface 14 substantially following the curvature of the internal structure 8 such that the duct 9 maintains a substantially constant cross section and therefore has a recess corresponding to the bulge 12 that is situated substantially facing said bulge when the movable cowl 10 is in the closed position. Furthermore, the internal surface 14 and the external surface 13 meet downstream of the movable cowl 10 to form an exhaust nozzle capable of ejecting the cold stream at a desired angle.

Thus, in the open position, the movable cowl 10 completely blocks off the duct 9, the bulge 12 bringing the internal structure 8 virtually into contact with an upstream portion of said movable cowl 10, give or take the functional operating clearance.

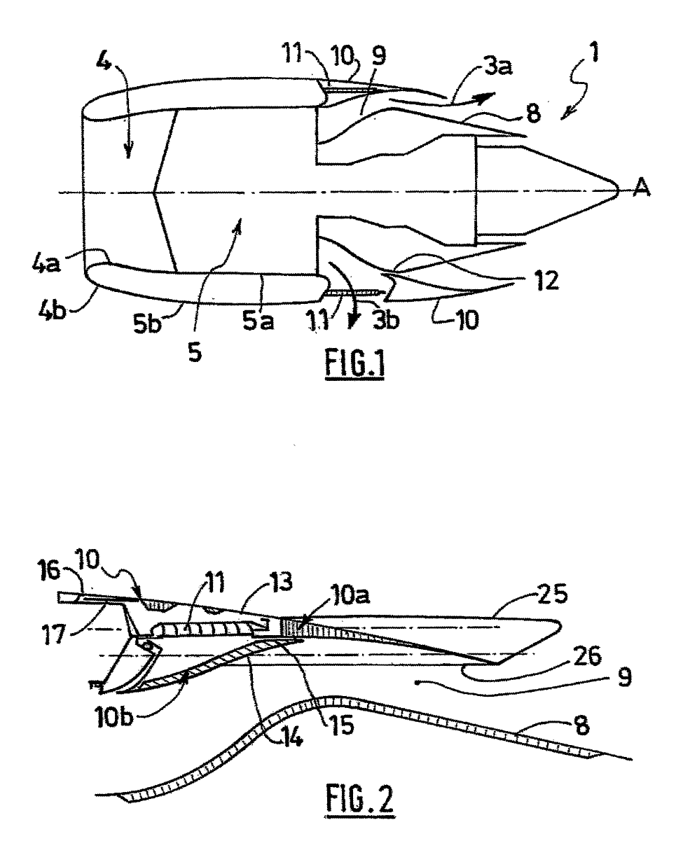

According to the invention, as represented in FIG. 2, the movable cowl 10 comprises an external portion 10a and an internal portion 10b which are independent of one another and which can each be moved parallel to a substantially longitudinal axis A of the nacelle.

The external portion 10a and the internal portion 10b are separated in the region of the recess of the internal surface 14 such that the internal surface 14 is formed, upstream of the recess, by a wall of the internal portion 10b of the movable cowl 10 and, downstream of the recess, by an internal wall of the external portion 10a, the external surface 13 being formed by an external wall of the external portion 10a. In this way, the internal surface 14 has a minimum aerodynamic discontinuity due to the interruption between the external portion 10a and the internal portion 10b.

In order to provide aerodynamic continuity of the internal surface 14 when the external portion 10a is moved away from the internal portion 10b, the internal wall of the external portion 10a has an extension 15 toward the inside of the movable cowl 10, the length of this extension depending on the degree of the maximum relative movement desired between the external portion 10a and the internal portion 10b.

In the same way, arrangements are provided to ensure the external aerodynamic continuity of the nacelle when the external portion 10a is moved. To this end, the central section 5 has, in the region of its interface with the movable cowl 10 of the thrust reverser, a slot 16 intended to receive a longitudinal wall 17 which extends the external wall of the external portion 10a of the movable cowl 10 over a distance which is slightly greater than the maximum distance of relative movement of the external portion 10a with respect to the internal portion 10b. The length of the longitudinal extension wall 17 and also the depth of the slot 16 are dependent on the degree of maximum separating and approach movements between the external portion 10a and the central structure 5.

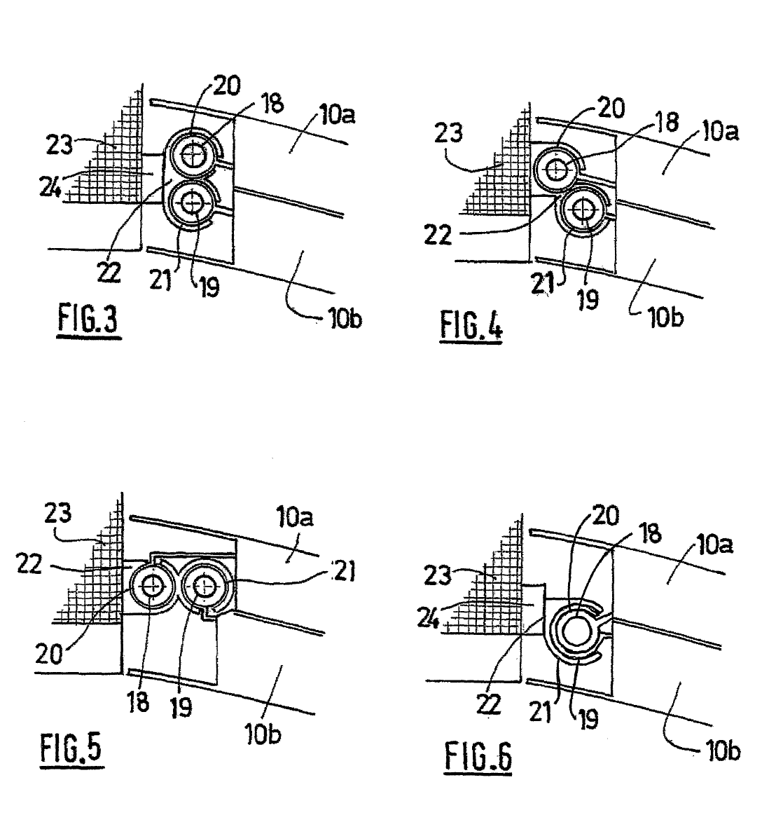

FIGS. 3 to 6 show various configurations of the guiding of the external 10a and internal 10b portions. To this end, each of the external 10a and internal 10b portions is equipped with at least one lateral guide rail 18, 19 able to slide inside a corresponding groove 20, 21 formed in a structure 22, preferably a common structure, connected directly or indirectly to a fixed structure 23 of the reverser or of the nacelle 1, such as the central structure 5, by means of a bearing structure 24.

Advantageously, attempts will be made to minimize the overall size of the guide means.

A preferred arrangement of the guide means is to obtain a substantially balanced positioning between, on the one hand, the axis of the guide rail 18 of the external portion 10a and the top of the external wall of said external portion 10a and, on the other hand, between the axis of the guide rail 19 of the internal portion 10b and the most remote point of the internal portion 10b.

This makes it possible to minimize the dimensions of an aerodynamic appendage 25 required to shroud the downstream external end of the nacelle 1 around the guide rail 18 of the external portion 10a and to minimize the dimensions of an aerodynamic appendage 26 required to shroud the duct 9 around the guide rail 19 of the internal portion 10b.

Advantageously still, the shape and the arrangement of the guide rails 18, 19 must be chosen such that the spacing between said guide rails 18, 19 is as small as possible in order to reduce the dimensions of the aerodynamic appendages 25, 26 to a minimum.

According to FIGS. 3 to 5, the grooves 20, 21 and guide rails 18, 19 of each external 10a and internal 10b portion of the movable cowl 10 can be superposed (FIG. 3), slightly offset (FIG. 4), or else aligned (FIG. 5), the spacing between the guide rails 18, 19 being minimal in the latter configuration and greatest in the first configuration.

Another possible configuration (FIG. 6) can consist in arranging the guide rail 18 inside the guide rail 19, which then serves as a groove therefor. In such a configuration, the guide rail 18 of the external portion 10a makes a smaller movement than its groove formed by the guide rail 19 of the internal structure.

According to a first embodiment represented in FIGS. 6 to 10, each of the external 10a and internal 10b portions is connected to a ram 28, 29 of pneumatic, hydraulic or electric type, preferably electric type, able to allow a longitudinal movement of the corresponding external 10a or internal 10b portion.

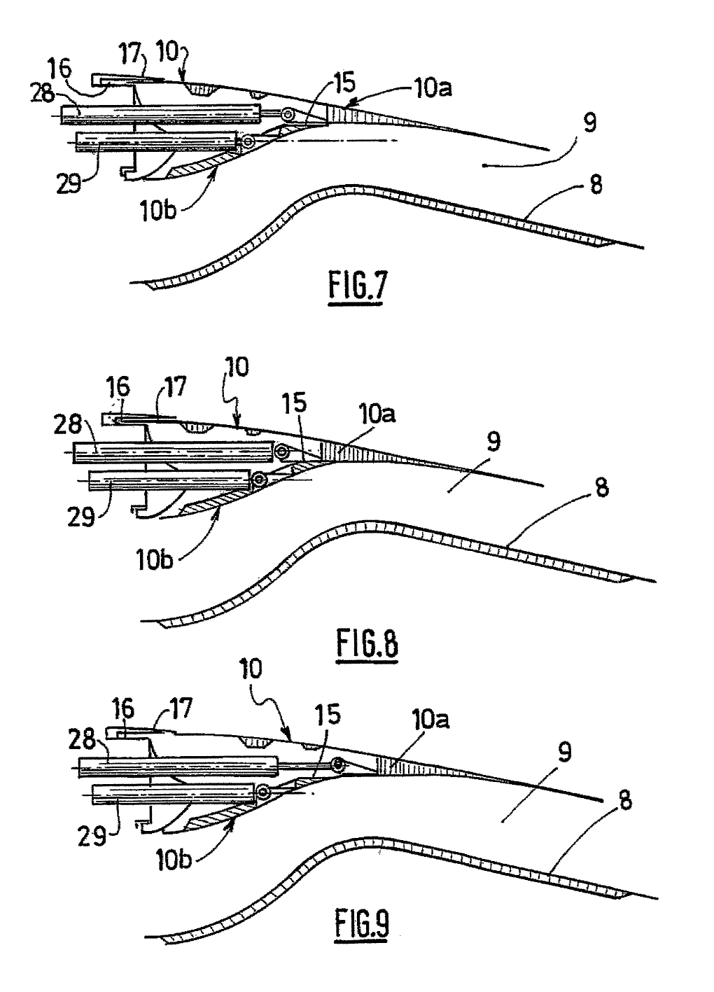

FIG. 7 shows the relative positions of the external portion 10a and the internal portion 10b of the movable cowl 10 when the latter is in a closed position in which it covers the deflection cascades 11 and has a conventional exhaust nozzle cross section.

The cross section of the nozzle can be easily modified by moving the external portion 10a and the internal portion 10b independently by means of their respective rams 28, 29.

FIG. 8 represents a thrust reverser in a closed position forming an exhaust nozzle of reduced cross section, the ram 28 of the external portion 10a being retracted to a maximum.

FIG. 9 represents a thrust reverser in a closed position forming an exhaust nozzle with an enlarged cross section, the ram 28 of the external portion 10a being deployed to move the external portion 10a relative to the internal portion 10b without interrupting the internal aerodynamic line by virtue of the extension 15 of the internal wall of the external portion 10a providing aerodynamic continuity with the internal portion 10b.

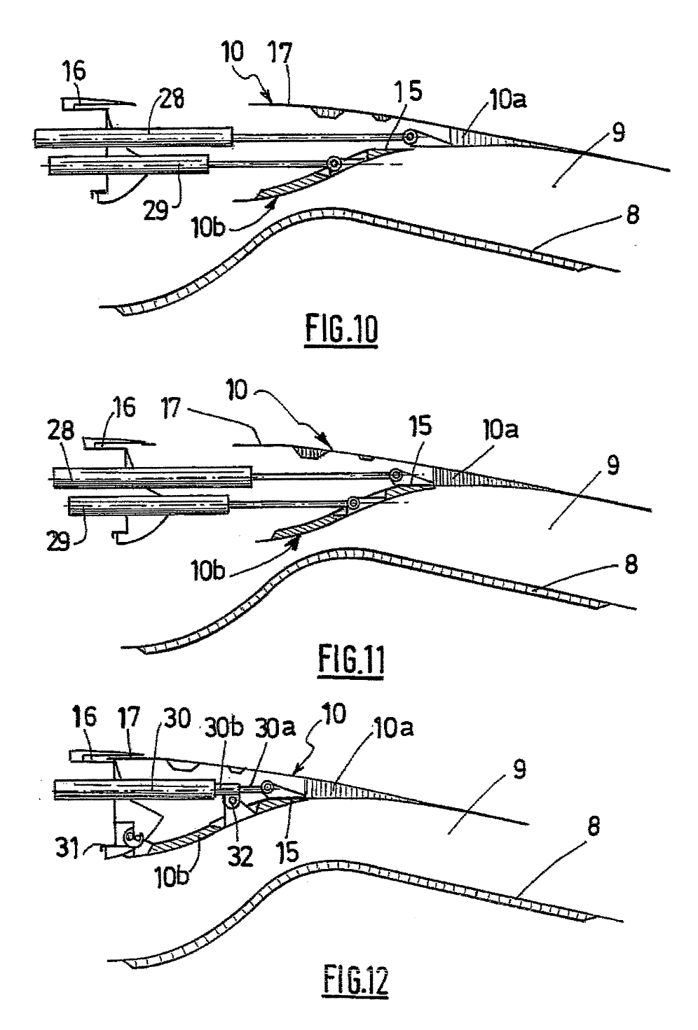

FIG. 10 represents a thrust reverser in an open thrust reversal position forming an exhaust nozzle of enlarged cross section, the external 10a and internal 10b portions being moved simultaneously from the position represented in FIG. 8.

FIG. 11 represents a thrust reverser in an open thrust reversal position forming an exhaust nozzle of conventional cross section.

The movable cowl 10 opens from the position represented in FIG. 8. In this position, only the ram 29 of the internal portion 10b is powered and moves the internal portion 10b in order to bring it into a position relative to the external portion 10a identical to that represented in FIG. 6 or identical to that represented in FIG. 7, a so-called compensating position. Once the compensating position has been reached, the rams 28, 29 of the external 10a and internal 10b portions are actuated simultaneously until the desired retreated reversal position is obtained. Such an opening method makes it possible to reduce the length of rectilinear movement of the ram 28 and to therefore reduce the length of the drive rail, thereby consequently making it possible to reduce the length of the aerodynamic shrouding appendage 25 protruding from the nacelle 1.

The movable cowl 10 closes in the same way in reverse. The important thing is to ensure that the opening cross section obtained between the external portion 10a and the central section 5 of the nacelle 1 or a fixed structure of the reverser is outside or equal to the opening cross section existing between the internal portion 10b and the central section 5 of the nacelle 1 or a fixed structure of the reverser.

According to a second embodiment represented in FIG. 12, the actuating means comprise a telescopic ram 30 having a first rod 30a connected to the external portion 10a and a second rod 30b connected to the internal portion 10b. As above, this telescopic ram 30 can be hydraulic, pneumatic or electric, preferably electric.

The assembly is supplemented by means 31 (means not shown) for locking the external 10a and internal 10b portions.

In the case of a hydraulic ram, the operations of reducing and increasing the cross section of the exhaust nozzle are carried out by means of a hydraulic pressure acting on the cross sections of the rods 30a, 30b. First of all, the first rod 30a, connected to the external portion 10a, is the one which is actuated. At the end of the retreating movement of the first rod 30a, the latter butts against the second rod 30b which in turn drives along the internal portion 10b of the movable cowl 10 after unlocking the means 31 for locking said internal portion 10b. The internal portion 10b may be attached to the second rod 30b by way of oblong eyes 32 arranged on either side of the second rod 30b, so as to reduce the overhang of the attachment point and avoid any hyperstaticity stress in the alignment of the internal portion 10b and the drive points of the external 10a and internal 10b portions.

The operation of the external 10a and internal 10b portions by the telescopic ram 30 allows a successive opening of the two portions, or a simultaneous combined opening, or the opening of the external portion 10a over at least part of its stroke.

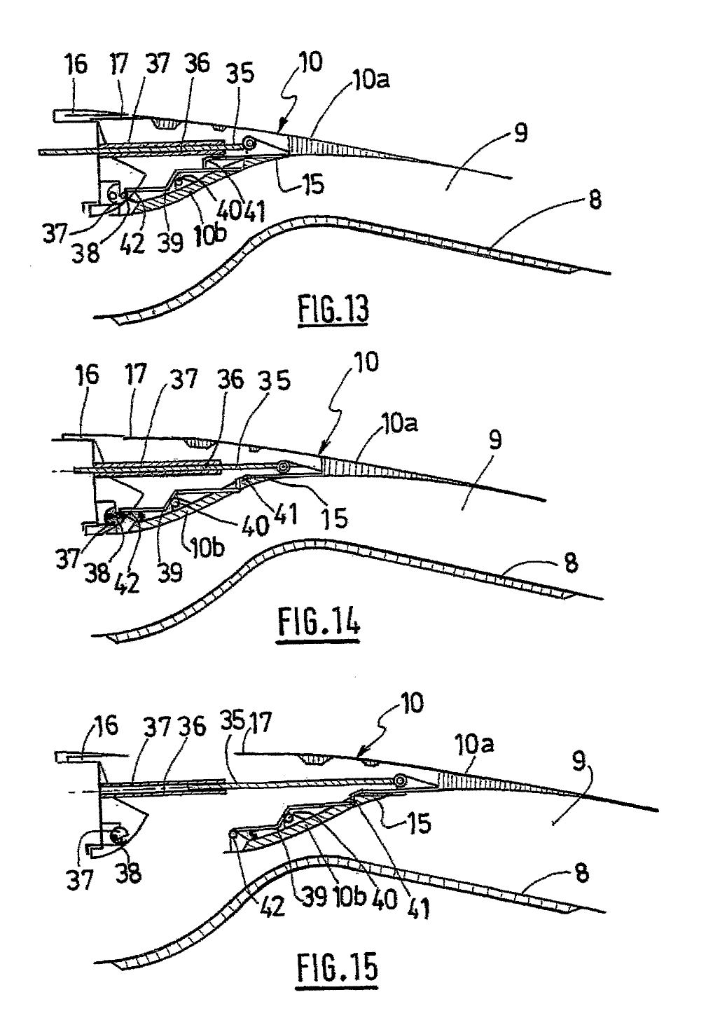

FIGS. 13 to 15 show a drive system for the external 10a and internal 10b portions that comprises a mechanical ball screw or roller screw system 35 connected to the external portion 10a and a fixed nut 36 connected to a fixed structure of the reverser or to the central structure 5 of the nacelle 1. The external portion 10a is driven either by a fixed screw on the external portion 10a or by a fixed nut on the external portion 10a. The drive power can be hydraulic, pneumatic or electric. More precisely, a sleeve 37 connected to a fixed structure of the reverser or to the central section 5 of the nacelle 1 supports the drive nut 36 used to drive the fixed screw 35 connected to the external portion 10a.

At least one lock 37 keeps the internal portion 10b at a fastening point 38 when the movable cowl 10 is in the closed position. When the lock 37 is thus closed, an element for locking the internal portion 10b with the external portion 10a is kept in an open position. Thus, the external portion 10a can slide independently of the internal portion 10b until an additional means for locking the external portion 10a engages with the internal portion 10b.

In this instance, the locking element is a rocker arm 39 articulated at a point 40 of the internal portion 10b and able to cooperate with a hook 41 which terminates the extension 15 of the internal wall of the external portion 10a.

As above, the cross section of the exhaust nozzle can be easily reduced by retracting the drive screw 35.

The cross section of the exhaust nozzle is increased in the same way by deploying the drive screw 35 until the hook 41 butts against the internal portion 10b.

The thrust reverser opens starting from the preceding position. The lock 37 is disengaged in order to release the internal portion 10b. In so doing, it returns, by way of a spring 42, the rocker arm 39 to the locking position behind the hook 41. The drive screw 35 is then deployed, driving both the external portion 10a and the internal portion 10b by way of the hook 41.

The movable cowl (10) is returned from its open position to its closed position in the same manner in reverse. The drive screw 35 is retracted and drives the external portion 10a. Since the hook 41 is blocked by the rocker arm 39, the movement of the external portion 10a also causes the movement of the internal portion 10b until the fastening point 38 engages with the lock 37. With the locking of the internal portion 10b, the rocker arm 39 returns to its position in which it releases the hook 41, and the external portion 10a on its own continues its movement into the selected position for obtaining the desired exhaust nozzle cross section in direct jet mode.

Although the invention has been described with specific exemplary embodiments, it is quite obvious that it is in no way limited thereto and that it covers all technical equivalents of the means described and combinations thereof where they come within the scope of the invention. In particular, it is possible to combine the various drive means described or to use other drive and locking means known to a person skilled in the art.

1. A thrust reverser for a turbine engine nacelle comprising, means for deflecting at least a fraction of an air stream of the turbine engine and, at least one cowl which can move translationally in a direction substantially parallel to a longitudinal axis of the nacelle and which is able to switch alternately from a closed position in which it provides aerodynamic continuity of the nacelle and covers the deflection means, to an open position in which it opens a passage in the nacelle and uncovers the deflection means, wherein the movable cowl comprises at least one external portion having a nozzle-forming downstream extension and at least one internal portion, each of these portions being mounted such that they can move translationally and being connected to at least one actuating means enabling them to move, independently of one another or together, in a substantially longitudinal direction of the nacelle.

2. The thrust reverser as claimed in claim 1, wherein the external portion can be equally caused to make an advancing movement in the upstream direction of the nacelle or a retreating movement in the downstream direction of the nacelle with respect to the internal portion.

3. The thrust reverser as claimed in claim 1, wherein the external portion and the internal portion are separated at the location of a recess of an internal aerodynamic line of the movable cowl.

4. The thrust reverser as claimed in claim 3, wherein the internal aerodynamic line recess is intended, when the movable cowl is in the closed position, to be situated facing a bulge of a casing of the turbine engine that, together with the internal aerodynamic line of the movable cowl, defines an inner duct.

5. The thrust reverser as claimed in claim 1, wherein the movable cowl is equipped, on the one hand, with a means for actuating one of the external or internal portions and, on the other hand, with locking means which are able to switch alternately from a locking position in which the external portion is connected to the internal portion, to an unlocking position in which the external portion or the internal portion connected to the actuating means is able to move independently of the other portion.

6. The thrust reverser as claimed in claim 5, wherein the actuating means is connected to the external portion.

7. The thrust reverser as claimed in claim 1 4, wherein the movable cowl is equipped with an actuating means for the external portion and with an actuating means specific to the internal portion which are able to be activated independently of one another so as to allow a simultaneous movement of the external portion and the internal portion and a relative movement between the external portion and the internal portion.

8. The thrust reverser as claimed in claim 1, wherein the actuating means comprise rams of the pneumatic, electric and/or hydraulic ram type.

9. The thrust reverser as claimed in claim 8, wherein the actuating means are a telescopic ram having a first rod which is able to allow the movement of the internal portion and a second rod which is able to allow the movement of the external portion, the two rods being able to be controlled synchronously or independently of one another.

10. The thrust reverser as claimed in claim 1, wherein the actuating means comprise a screw/nut actuating system which can be actuated pneumatically, electrically and/or hydraulically.

11. The thrust reverser as claimed in claim 1, wherein the external and internal portions are equipped with guide mans which are able to cooperate with complementary guide means connected to a fixed portion of the nacelle.

12. The thrust reverser as claimed in claim 11, wherein the guide means are rails which are able to cooperate with corresponding grooves.

13. The thrust reverser as claimed in claim 12, wherein the rails of the external portion and of the internal portion are separate.

14. The thrust reverser as claimed in claim 12, wherein the rail of the external portion is integrated into the rail of the internal portion.

15. A turbine engine nacelle comprising at least one thrust reverser as claimed in claim 1.

16. The turbine engine nacelle as claimed in claim 15, wherein it is a nacelle for a bypass turbine engine, preferably with a high bypass ratio.

17. The turbine engine nacelle as claimed in claim 15, wherein the thrust reverser is a natural blockage thrust reverser.
